(19) United States
(12) Patent Application Publication
(10) Pub. No.: US 2026/0217921 A1
(43) Pub. Date: Jul. 30, 2026

(54) LIQUID PLASTISOL COMPOSITIONS AND WATER SOLUBLE PLASTICIZED ARTICLES PREPARED THEREFROM

(71) Applicant: Avient Corporation, Avon Lake, OH (US)

(72) Inventors: Karl Heldt, North Wales, PA (US); David Lee, Landsdale, PA (US); Michael Rhodes, Chalfont, PA (US)

(73) Assignee: Avient Corporation, Avon Lake, OH (US)

(21) Appl. No.: 19/143,707

(22) PCT Filed: Dec. 15, 2023
(86) PCT No.: PCT/US2023/084409

§ 371 Date: Jun. 26, 2025

Related U.S. Application Data
(60) Provisional application No. 63/436,095, filed on Dec. 29, 2022.

(51) Int. Cl. C08J 3/11; C08J 5/18; C08L 1/28; C08L 29/04; C08L 71/02; C08L 99/00

(52) U.S. Cl. CPC C08J 3/11; C08J 5/18; C08L 1/284; C08L 29/04; C08L 71/02; C08L 99/00; C08J 2301/28; C08J 2329/04; C08J 2351/08; C08J 2371/02; C08J 2399/00; C08J 2429/04; C08J 2439/06; C08L 2201/56; C08L 2205/06

(57) ABSTRACT

Embodiments of the present disclosure are directed to liquid plastisol compositions and articles made therefrom. The liquid plastisol composition includes, based on a total weight of the liquid plastisol composition, 3 wt. % to 60 wt. % water soluble polymer particles and 40 wt. % to 97 wt. % plasticizer. The water soluble polymer particles have an average particle size from 1 micron to 500 microns.

### CLAIM OF PRIORITY

This application claims the benefit of U.S. Provisional Patent Application Ser. No. 63/436,095 bearing Attorney Docket Number 1202226 and filed on Dec. 29, 2022, which is hereby incorporated by reference in its entirety.

### TECHNICAL FIELD

Embodiments of the present disclosure are generally related to liquid plastisol compositions and water soluble plasticized articles prepared therefrom.

### BACKGROUND

Water soluble plastics may be desirable for single-use applications because their ecological footprint is minimal. However, some conventional processes used to form water soluble plastics may require specialized thermoforming equipment. Other conventional processes include film casting, which involves dissolving the water soluble polymers in solvent and obtaining a film after the solvent is vaporized. Casting from solvents may produce volatile organic compounds. Casting from water-based solutions may require high thermal energy input to evaporate the water. Moreover, conventional processes used to form plasticized articles or films, particularly those having a relatively large size (e.g., at least one dimension greater than 200 microns), may result in the formation of defects (e.g., blisters).

Accordingly, there is a need for a new and more cost-effective and less energy-intensive solution for forming water soluble plastics including water soluble polymer particles and having a desirable size and being essentially blister free.

### SUMMARY

Embodiments of the present disclosure are directed to liquid plastisol compositions comprising water soluble polymer particles and plasticizers, and water soluble plasticized articles prepared therefrom.

According to one embodiment, a liquid plastisol composition is provided. The liquid plastisol composition comprises, based on a total weight of the liquid plastisol composition, 3 wt. % to 50 wt. % water soluble polymer particles and 50 wt. % to 97 wt. % plasticizer. The water soluble polymer particles have an average particle size of 1 micron to 500 microns.

According to another embodiment, a method for preparing a plasticized composition is provided. The method comprises providing a liquid plastisol composition, pouring the liquid plastisol composition into a mold, and heating the liquid plastisol composition to form a gelled plastisol article. The liquid plastisol composition comprises, based on a total weight of the liquid plastisol composition: 3 wt. % to 60 wt. % water soluble polymer particles and 40 wt. % to 97 wt. % plasticizer. The water soluble polymer particles have an average particle size from 1 micron to 500 microns.

According to another embodiment, a plasticized article is provided. The plasticized article comprises a liquid plastisol composition comprising, based on a total weight of the liquid plastisol composition, 3 wt. % to 60 wt. % water soluble polymer and 40 wt. % to 90 wt. % plasticizer. The plasticized article comprises a length, a width, and a thickness, each being at least 200 microns.

According to another embodiment, a plasticized film is provided. The plasticized film comprises a liquid plastisol composition comprising, based on a total weight of the liquid plastisol composition, 3 wt. % to 60 wt. % water soluble polymer and 40 wt. % to 90 wt. % plasticizer. The plasticized film comprises a length, a width, and a thickness, and the thickness is greater than 200 microns.

Additional features and advantages of the embodiments described herein will be set forth in the detailed description which follows, and in part will be readily apparent to those skilled in the art from that description or recognized by practicing the embodiments described herein, including the detailed description, which follows and the claims.

### DRAWINGS

FIG. 1 is a schematic of a plasticized article or film, according to one or more embodiments shown and described herein;

FIG. 2 is a photograph of a plasticized article, according to one or more embodiments described herein; and

FIG. 3 is a photograph of a plasticized article, according to one or more embodiments described herein.

### DETAILED DESCRIPTION

Embodiments of the present disclosure are directed to liquid plastisol compositions comprising water soluble polymer particles and plasticizer. In the present disclosure, the liquid plastisol compositions comprising water soluble polymer particles and plasticizer may simply be referred to as the “liquid plastisol compositions.” The liquid plastisol compositions may be used to prepare dissolvable permanently plasticized solid products. In the present disclosure, permanently plasticized solid products prepared using the liquid plastisol compositions may be referred to as “water soluble plasticized articles,” “water soluble plasticized articles and films,” “plasticized articles,” and “plasticized articles and films” Notwithstanding the foregoing, films may be considered plasticized articles. Advantageously, the liquid plastisol compositions disclosed herein may be used to prepare plasticized articles have a desirable size. Moreover, the plasticized articles may be blister free or essentially blister free.

The disclosure should not be construed as limited to the embodiments set forth herein. Rather, these embodiments are provided so that this disclosure will be thorough and complete, and will fully convey the subject matter to those skilled in the art.

### Definitions

Unless otherwise defined, all technical and scientific terms used herein have the same meaning as commonly understood by one of ordinary skill in the art. The terminology used in the disclosure herein is for describing particular embodiments only and is not intended to be limiting.

Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used in the specification and the appended claims, the singular forms “a,” “an,” and “the” are intended to include the plural forms as well, unless the context clearly indicates otherwise. Thus, for example, reference to “a” component includes aspects having two or more such components, unless the context clearly indicates otherwise.

The term “essentially water free,” as described herein, refers to compositions containing hygroscopic ingredients such that no water is added to or needed in the composition.

The term “essentially blister free,” as described herein, refers to no blisters being present in the liquid plastisol composition, where blisters are bubble-like domains forming at the solid-liquid interface of the liquid plastisol composition during heating to form an article or a film.

The terms “water soluble,” “dissolvable” or “dissolved,” as described herein, refer to least 1 gram of polymer, plasticized article or film being dissolvable for every 30 grams of deionized water at standard temperature (20° C.) and pressure (1 atm) on visual inspection.

The term “room temperature,” as used herein, refers to 20° C.

The term “wt. %,” as described herein, refers to wt. % based on the weight of the water soluble liquid plastisol composition, unless otherwise noted.

The term “plastisol,” as described herein, refers to formulations comprising polymer particles suspended in liquid plasticizer. When sufficiently heated, the polymer particles absorb the plasticizer causing the polymer particles to fuse together to form a gel resulting in permanently plasticized solid product.

The term “plasticizer,” as described herein, refers to a molecule or substance added to a composition to promote a composition's plasticity and flexibility.

The term “gelation temperature,” as described herein, refers to the temperature at which the peak viscosity is measured using a Rheometric Dynamic Analyzer (RDA) from BASF.

As discussed hereinabove, water soluble polymers may be desirable for single-use applications because their ecological footprint is minimal. However, some conventional processes used to form water soluble polymers may require specialized thermoforming equipment. Additionally, conventional processes may utilize water insoluble polymer particles. Other conventional processes include film casting, which involves dissolving the water soluble polymers in solvent and obtaining a film after the solvent is vaporized. Casting from solvents may produce volatile organic compounds. Casting from water-based solutions may require high thermal energy input to vaporize the water. Moreover, conventional processes used to form plasticized articles or films, particularly those having a relatively large size (e.g., at least one dimension greater than 200 microns), may result in the formation of defects (e.g., blisters).

Disclosed herein are liquid plastisol compositions, which mitigate one or more of the aforementioned problems. Specifically, when the liquid plastisol compositions disclosed herein are heated, the plasticizer of the liquid plastisol infuses the water soluble polymer particles and the water soluble polymer particles swell to form the water soluble plasticized article or film. The liquid plastisol composition disclosed herein does not require specialized thermoforming equipment or casting from solvents or water-based solutions to form a water soluble plasticized article or a film. Accordingly, the liquid plastisol compositions described herein combine the benefits of using water soluble polymers with the ease of plastisol processing to form water soluble plasticized articles and films having a desirable size and being essentially blister free.

### Water Soluble Polymer Particles

Liquid plastisol compositions may be obtained by combining water soluble polymer particles and a plasticizer. The water soluble polymer particles provide the ability for the resulting plasticized article or film to dissolve, disperse, or swell in water. In embodiments, the plasticized article or film dissolves in water. In embodiments, the water soluble polymer particles included in the liquid plastisol compositions disclosed herein may comprise natural or synthetic polymers.

In embodiments, the water soluble polymer particles may comprise a natural water soluble polymer selected from the group consisting of polysaccharides, polypeptides, and combinations thereof. For example, in embodiments, the water soluble polymer particles may comprise hydroxyethyl cellulose, wheat gluten powder, sodium alginate, gelatin, or combinations thereof. Water soluble polymers selected from this group may be desirable in food or medical grade applications.

In other embodiments, the water soluble polymer particles may comprise a synthetic water soluble polymer. In embodiments, the water soluble polymer may be selected from the group consisting of polyvinyl alcohols, polyacrylic acid copolymer, poly(2-ethyl-2-oxazoline), and combinations thereof. For example, in embodiments, the water soluble polymer particles may comprise poly(acrylic acid), poly(vinyl alcohol), poly(ethylene glycol)-poly(vinyl alcohol) graft copolymer, polyvinyl pyrrolidone, or combinations thereof.

The ability of the water soluble polymer particles to dissolve may be effected by the pH level of liquid being used to dissolve the plasticized film or article (e.g., water). For example, some water soluble polymers may have relatively poor solubility in neutral or acidic conditions. The liquid plastisol compositions disclosed herein may be adjusted to account for the pH level of the dissolving liquid. In embodiments, a buffer may be employed in the liquid plastisol composition to provide a suitable pH level for the water soluble polymers of the plasticized film or article to dissolve in water. In embodiments, an acid may be employed in the liquid plastisol composition to provide a suitable pH level for the water soluble polymers of the plasticized film or article to dissolve in water. In embodiments, a base may be employed in the liquid plastisol composition to provide a suitable pH level for the water soluble polymers of the plasticized film or article to dissolve in water.

The liquid plastisol composition may comprise a minimum amount of water soluble polymer particles (i.e., greater than or equal to 3 wt. %) to ensure a desired form (e.g., article or film) is achieved. The amount of water soluble polymer particles may be limited (e.g., less than or equal to 50 wt. %) such that a desired viscosity is achieved for processing purposes (e.g., pouring into mold). Accordingly, in embodiments, the liquid plastisol composition may comprise, based on a total weight of the liquid plastisol composition, 3 wt. % to 50 wt. % water soluble polymer particles. In embodiments, the amount of the water soluble polymer particles in the liquid plastisol composition may be, based on a total weight of the liquid plastisol composition, greater than or equal to 3 wt. %, greater than or equal to 5 wt. %, greater than or equal to 10 wt. %, or even greater than or equal to 15 wt. %. In embodiments, the amount of the water soluble polymer particles in the liquid plastisol composition may be, based on a total weight of the liquid plastisol composition, less than or equal to 60 wt. %, less than or equal to 55 wt. %, less than or equal to 50 wt. %, less than or equal to 45 wt. %, less than or equal to 40 wt. %, less than or equal to 35 wt. %, less than or equal to 30 wt. %, or even less than or equal to 25 wt. %. In embodiments, the amount of the water soluble polymer particles in the liquid plastisol composition may be, based on a total weight of the liquid plastisol composition, from 3 wt. % to 50 wt. %, from 3 wt. % to 45%, from 3 wt. % to 40 wt. %, from 3 wt. % to 35 wt. %, from 3 wt. % to 30 wt. %, from 3 wt. % to 25 wt. %, from 5 wt. % to 50 wt. %, from 5 wt. % to 45%, from 5 wt. % to 40 wt. %, from 5 wt. % to 35 wt. %, from 5 wt. % to 30 wt. %, from 5 wt. % to 25 wt. %, from 10 wt. % to 50 wt. %, from 10 wt. % to 45%, from 10 wt. % to 40 wt. %, from 10 wt. % to 35 wt. %, from 10 wt. % to 30 wt. %, from 10 wt. % to 25 wt. %, from 15 wt. % to 50 wt. %, from 15 wt. % to 45%, from 15 wt. % to 40 wt. %, from 15 wt. % to 35 wt. %, from 15 wt. % to 30 wt. %, or even from 15 wt. % to 25 wt. %, or any and all subranges formed from any of these endpoints.

Water soluble polymer particles with a small average particle size may be used to ensure that the water soluble polymer particles form an article or film where the water soluble polymer particles have fully absorbed the plasticizer to form consistent gel. In embodiments, the water soluble polymer particles may be provided in powder form. In embodiments, the water soluble polymer particles may be milled to produce a desired average particle size. In embodiments, the water soluble polymer may have a minimum average particle size (e.g., greater than or equal to 1 micron) to ensure that the water soluble polymer particles do not agglomerate and are not too fine to handle. In embodiments, the average particle size of the water soluble polymer particle may be limited (e.g., less than or equal to 500 microns) to ensure that the water soluble polymer particles may be fully infused and gel to form a consistent article or film. Accordingly, in embodiments, the average particle size of the water soluble polymer particles in the liquid plastisol composition may be from 1 micron to 500 microns. In embodiments, the average particle size of the water soluble polymer particles in the liquid plastisol composition may be greater than or equal to 1 micron, greater than or equal to 50 microns, or even greater than or equal to 100 microns. In embodiments, the average particle size of the water soluble polymer particles in the liquid plastisol composition may be less than or equal to 500 microns, less than or equal to 450 microns, less than or equal to 400 microns, less than or equal to 350 microns, less than or equal to 300 microns, or even less than or equal to 250 microns. In embodiments the average particle size of the water soluble polymer particles in the liquid plastisol composition may be from 1 micron to 500 microns, from 1 micron to 450 microns, from 1 micron to 400 microns, from 1 micron to 350 microns, from 1 micron to 300 microns, from 1 micron to 250 microns, 50 micron to 500 microns, from 50 micron to 450 microns, from 50 micron to 400 microns, from 50 micron to 350 microns, from 50 micron to 300 microns, from 50 micron to 250 microns, 100 micron to 500 microns, from 100 micron to 450 microns, from 100 micron to 400 microns, from 100 micron to 350 microns, from 100 micron to 300 microns, or even from 100 micron to 250 microns, or any and all subranges formed from any of these end points.

Suitable commercial embodiments of the water soluble polymer particles are available from Ashland, such as polyvinylpyrrolidone grade PVP K-120; under the KOLLICOAT brand from BASF, such as poly(ethylene glycol)-poly(vinyl alcohol) graft copolymer grade IR; under the POVAL brand from Kuraray, such as poly(vinyl alcohol) grade 49-88 S2; under the CELLOSIZE brand from Dow Chemical, such as grade QP 300; and from Naturtonix, such as premium vital wheat gluten.

### Plasticizer

Suitable plasticizers for use in the liquid plastisol compositions of the present disclosure include those plasticizers that form a liquid dispersion or slurry when combined with the water soluble polymer particles. Upon sufficient heating, the water soluble polymer particles in the liquid plastisol composition absorb the plasticizer, causing the water soluble polymer particles to swell and fuse together forming gel. The resultant product is a permanently plasticized solid product.

In embodiments, the plasticizer may comprise a polyol. In embodiments, the polyol may be a diol. In other embodiments, the polyol may be a triol. In still other embodiments, the polyols may include 4, 5, or more than 6 hydroxyl groups. In embodiments, a polyols may be selected that exhibits similar polarity to the water soluble polymer particle chosen. Plasticizers selected from this group may also be advantageous in applications involving short-life applications such as food packaging. In embodiments, the plasticizer may be selected from the group consisting of glycols, sugar alcohols, sugars, glycerol, triacetin, propylene carbonate, fatty acids, urea, and combinations thereof. Exemplarily glycols include propylene glycol and poly(ethylene) glycols (“PEG”). Suitable poly(ethylene) glycols should be liquids at 22° C. (e.g., PEGs with a MW of 600 g/mol or less). In embodiments, the poly(ethylene) glycol may have a MW in the range of 100 g/mol to 600 g/mol, 200 g/mol to 550 g/mol, or 300 g/mol to 500 g/mol,

In embodiments, a minimum amount of plasticizer may be included in the liquid plastisol composition (e.g., greater than or equal to 40 wt. %) to ensure a liquid property is imparted to the composition. The amount of plasticizer in the liquid plastisol composition may be limited (e.g., less than or equal to 97 wt. %) to ensure a consistent article or film is formed. Accordingly, in embodiments, the liquid plastisol composition may comprise, based on a total weight of the liquid plastisol composition, 40 wt. % to 97 wt. % plasticizer. In embodiments, the amount of the plasticizer in the liquid plastisol composition may be, based on a total weight of the liquid plastisol composition, greater than or equal to 40 wt. %, greater than or equal to 45 wt. %, greater than or equal to 50 wt. %, greater than or equal to 55 wt. %, greater than or equal to 60 wt. %, or even greater than or equal to 65 wt. %. In embodiments, the amount of the plasticizer in the liquid plastisol composition may be, based on a total weight of the liquid plastisol composition, less than or equal to 97 wt. %, less than or equal to 95 wt. %, less than or equal to 90 wt. %, or even less than or equal to 85 wt. %. In embodiments, the amount of the plasticizer in the liquid plastisol composition may be, based on a total weight of the liquid plastisol composition, from 40 wt. % to 97 wt. %, from 40 wt. % to 95 wt. %, from 40 wt. % to 90 wt. %, from 40 wt. % to 85 wt. %, from 45 wt. % to 97 wt. %, from 45 wt. % to 95 wt. %, from 45 wt. % to 90 wt. %, from 55 wt. % to 85 wt. %, from 50 wt. % to 97 wt. %, from 50 wt. % to 95 wt. %, from 50 wt. % to 90 wt. %, from 50 wt. % to 85 wt. %, from 55 wt. % to 97 wt. %, from 55 wt. % to 95 wt. %, from 55 wt. % to 90 wt. %, from 55 wt. % to 85 wt. %, from 60 wt. % to 97 wt. %, from 60 wt. % to 95 wt. %, from 60 wt. % to 90 wt. %, from 60 wt. % to 85 wt. %, from 65 wt. % to 97 wt. %, from 65 wt. % to 95 wt. %, from 65 wt. % to 90 wt. %, or even from 65 wt. % to 85 wt. %, or any and all subranges formed from any of these endpoints.

Suitable commercial embodiments of the plasticizers are available from Nature's Oil, such as USP Grade glycerol and propylene glycol; and from Consolidated Chemical and Solvents, such as polyethylene glycol grade PEG 400.

### Liquid Plastisol Composition

As described herein, the liquid plastisol compositions disclosed herein comprise water soluble polymer particles and plasticizer, which do not require specialized thermoforming equipment or casting from solvents or water-based solutions to form a water soluble plasticized article or a film. Instead, when heated, the plasticizer of the liquid plastisol compositions described herein swells the water soluble polymer particles and fuses to form the water soluble plasticized article or the film upon cooling.

### Additives

Other compounds may be added to the liquid plastisol composition of the present disclosure in order to improve the ease of processing, cost, performance, or service life. Examples include, but not limited to, viscosity modifiers, viscosity stabilizers, heat stabilizers, preservatives, fillers, colorants, adhesion promoter, lubricants, and combinations thereof. As discussed below, food coloring may be used to in embodiments of the plasticized articles.

In embodiments, the amount of the additives in the liquid plastisol composition may be, based on a total weight of the liquid plastisol composition, from 1 wt. % to 20 wt. %. In embodiments, the amount of the additives in the liquid plastisol composition, based on a total weight of the liquid plastisol composition, may be greater than or equal to 1 wt. %, greater than or equal to 3 wt. %, or even greater than or equal to 5 wt. %. In embodiments, the amount of the additives in the liquid plastisol composition may be, based on a total weight of the liquid plastisol composition, less than or equal to 20 wt. %, less than or equal to 15 wt. %, or even less than or equal to 10 wt. %. In embodiments, the amount of the additives in the liquid plastisol composition may be, based on a total weight of the liquid plastisol composition, from 1 wt. % to 20 wt. %, from 1 wt. % to 15 wt. %, from 1 wt. % to 10 wt. %, from 3 wt. % to 20 wt. %, from 3 wt. % to 15 wt. %, from 3 wt. % to 10 wt. %, from 5 wt. % to 20 wt. %, from 5 wt. % to 15 wt. %, or even from 5 wt. % to 10 wt. %, or any and all subranges formed from any of these endpoints.

Advantageously, plasticized articles films and may be prepared from the liquid plastisol composition without the need for water. In embodiments, the liquid plastisol composition may be essentially water free. In embodiments, the liquid plastisol composition may be, based on a total weight of the liquid plastisol composition, less than 5 wt. %, less than 3 wt. %, less than 1 wt. %, less than 0.5 wt. %, or less than 0.1 wt. % water.

### Processing

In embodiments, any plasticized article described herein may be made with a batch process or continuous process using the liquid plastisol composition of the present disclosure.

In embodiments, a method of preparing a plasticized article may comprise providing a liquid plastisol composition as described herein, pouring the liquid plastisol composition into a mold, and heating the liquid plastisol composition to form a gelled plastisol article or film. In embodiments, the method may further comprising cooling the gelled plastisol article or film (e.g., to room temperature) to form the plasticized article or film.

In embodiments, the step of providing a liquid plastisol composition may comprise blending the water soluble polymer particles with the plasticizer to form a slurry and mixing until the slurry is homogenous. In embodiments, the water soluble polymer particles may be in powder form. Additives, as described herein, may optionally be blended with the water soluble particles and the plasticizer to form the slurry.

In embodiments, the step of pouring the liquid plastisol composition into a mold may comprise pouring the slurry into a mold. The mold may have any desirable shape and/or size, depending on the intended application of the resulting plasticized article or film.

In embodiments, the step of heating the liquid plastisol composition to form the gelled plastisol article or film may comprise heating the liquid plastisol composition to a gelation temperature. The gelation temperature refers to the temperature of the oven within which the liquid plastisol composition is heated. In embodiments, the gelation temperature may be in the range of from 90° C. to 170° C., from 90° C. to 155° C., from 90° C. to 140° C., 105° C. to 170° C., from 105° C. to 155° C., from 105° C. to 140° C., from 120° C. to 170° C., from 120° C. to 155° C., or even from 120° C. to 140° C. In embodiments, the liquid plastisol composition may be heated at the gelation temperature for the time required to heat the entire article or film, including internal portions, to the gelation temperature. The viscosity of the liquid plastisol composition will increase as the liquid plastisol composition is heated to the gelation temperature to form the gelled plastisol. The gelled plastisol is then cooled to form a solid film or article. Additionally, the gelled plastisol may appear translucent due to the disappearance of grain boundaries formed by the two distinct phases.

In embodiments, the components of the liquid plastisol composition, including the water soluble polymer particles and plasticizer, may be formed into an article or film by screen printing, roll coating, spray coating, slot die coating, dip molding, dip coating, spin coating, rotomolding, slush casting, injection molding, or extruding. Other ways of forming the liquid plastisol composition into an article are contemplated and within the scope of the present disclosure.

### Plasticized Articles and Films

As described hereinabove, conventional processes used to form plasticized articles or films, particularly those having a relatively large size (e.g., at least one dimension greater than 200 microns) may result in the formation of defects (e.g., blisters). For example, during heating to form the plasticized articles or films, a film may form on the top surface of the liquid plastisol composition. As the internal part of the composition is heated, the solvent or water in the conventional composition begins to evaporate, which may cause blistering of the film. However, utilizing the liquid plastisol composition as described herein, which are not cast from solvents or water-based solutions, results in plasticized articles and films that are essentially blister free because little to no evaporation occurs during processing. In embodiments, the plasticized article or film 100 may be essentially blister free when viewed at normal viewing angles from a distance of not less than 1000 mm.

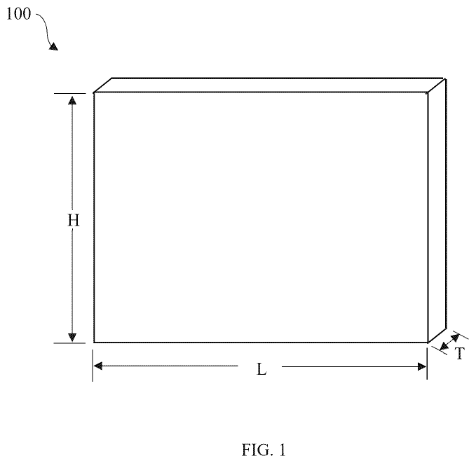

Referring now to FIG. 1, a plasticized article or film 100 comprises a liquid plastisol composition as described herein. The plasticized article or film 100 comprises a length L, a width W, and a thickness T.

Advantageously, the liquid plastisol composition may be used to prepare well-formed plasticized articles with large dimensions. In embodiments including a plasticized article 100, each of the length L, the width W, and the thickness T of the plasticized article 100 may be at least 200 microns, at least 500 microns, at least 1 mm, at least 2 mm, at least 3 mm, at least 4 mm, at least 5 mm, at least 10 mm, at least 20 mm, at least 30 mm, at least 40 mm, at least 50 mm, at least 60 mm, at least 70 mm, at least 80 mm, at least 90 mm, or at least 100 mm. In embodiments including a plasticized article 100, each of the length L, the width W, and the thickness T of the plasticized article 100 may be in the range of 200 microns to 300 mm, 500 microns to 200 mm, 1 mm to 150 mm, 2 mm to 125 mm, or any and all subranges formed from any of these endpoints.

In embodiments including a plasticized article 100, each of the length L, the width W, and the thickness T of the plasticized article 100 may be at least 200 microns, with one or more L, W, and T being at least 500 microns, at least 1 mm, at least 2 mm, at least 3 mm, at least 4 mm, at least 5 mm, at least 10 mm, at least 20 mm, at least 30 mm, at least 40 mm, at least 50 mm, at least 60 mm, at least 70 mm, at least 80 mm, at least 90 mm, or at least 100 mm. In embodiments each of the length L, the width W, and the thickness T of the plasticized article 100 may be at least 200 microns, with one or more L, W, and T being in the range of 200 microns to 300 mm, 500 microns to 200 mm, 1 mm to 150 mm, 2 mm to 125 mm, or any and all subranges formed from any of these endpoints.

In embodiments, the plasticized article 100 may be any desirable shape, depending on the intended application of the plasticized article, such as a geometric shape or an irregular shape.

Those skilled in the art will appreciate that when plasticized article 100 is a film, L and W may be substantially greater than T. In embodiments where the plasticized article 100 is a film, T may be at least 200 microns, 250 microns, 300 microns, 350 microns, 400 microns, 450 microns, or 500 microns, where L and W are each longer than T. In embodiments where the plasticized article 100 is a film, T may be in the range of 200 microns to 1 mm, 250 microns to 950 microns, 300 microns to 900 microns, 350 microns to 850 microns, 400 microns to 800 microns, 450 microns to 750 microns, or 500 microns to 700 microns, or any and all subranges formed from any of these endpoint, and wherein L and W are each longer than T

In embodiments, the plasticized film 100 may be a single layer film. That is, the plasticized film 100 may be made of a single layer of material (e.g., the plasticized film formed upon heating). In other embodiments, the plasticized film 100 may be a multilayer film. A multilayer film differs from a single layer film in that multilayer films contain multiple polymers and/or substrates that may require adhesion between layers of material.

Advantageously, the plasticized articles and films may dissolve in water. In embodiments, at least 1 gram of plasticized article or film may be dissolvable in 30 gram of deionized water at standard temperature (20° C.) and pressure (1 atm) and forms a solution in water on visual inspection. “Forms a solution in water on visual inspection” means there is visually no undissolved portion of the plasticized article or film remaining in the solution.

### Examples

Table 1 below shows sources of ingredients used to form Examples E1 to E8.

TABLE 1

| | Chemical | | |
|---|---|---|---|
| Ingredient | Description | Brand and Grade | Source |
| natural water soluble | hydroxyethyl cellulose | CELLOSIZE QP 300 | Dow Chemical |
| polymer particles | wheat gluten powder | Premium Vital Wheat | Naturtonix |
| | | Gluten | |
| synthetic water soluble | polyvinylpyrrolidone | PVP K-120 | Ashland |
| polymer particles | poly(acrylic acid) | MW 1,000,000 | Polysciences |
| | | Poly(acrylic acid) | |
| | poly(ethylene | KOLLICOAT IR | BASF |
| | glycol)-poly(vinyl | | |
| | alcohol) graft | | |
| | copolymer | | |
| | poly(vinyl alcohol) | POVAL 49-88 S2 | Kuraray |
| plasticizer | glycerol | USP Grade Glycerol | Nature's Oil |
| | propylene glycol | USP Grade Propylene | Nature's Oil |
| | | Glycol | |
| | poly(ethylene glycol) | MW 400 Poly(ethylene | Consolidated |
| | | glycol) | Chemical and |
| | | | Solvents |
| additive | green food coloring | Green | McCormick |

Tables 2-5 below show the formulations used to form and the certain properties of Examples E1 to E8.

To form Example E1, 2.5 grams of CELLOSIZE QP 300 (water soluble polymer particles) was blended with 7.5 grams of USP Grade glycerol (plasticizer) to form a slurry. The slurry was poured into an aluminum dish and was heated in an oven at 170° C. for 30 seconds. A white plasticized film was obtained upon cooling to room temperature. The film formed a solution in room temperature water on visual inspection.

To form Example E2, 3 grams of Premium Vital Wheat Gluten (water soluble polymer particles) was blended with 6 grams of USP grade glycerol (plasticizer) to form a slurry. The slurry was poured into an aluminum dish and was heated in an oven at 170° C. for 30 seconds. A brown plasticized film was obtained upon cooling to room temperature. The film formed a solution in room temperature water on visual inspection.

TABLE 2

| | E1 | E2 |
|---|---|---|
| | Wt. % | Wt. % |
| CELLOSIZE QP 300 | 25.00 | — |
| USP Grade Glycerol | 75.00 | 66.67 |
| Premium Vital Wheat Gluten | — | 33.33 |
| TOTAL | 100.00 | 100.00 |
| Dissolved in Room Temperature Water | Yes | Yes |

To form Example E3, 1 gram of PVP K-120 (water soluble polymer particles) was blended with 5 grams of MW 400 Poly(ethylene glycol) (plasticizer) to form a slurry. The slurry was poured into an aluminum dish and was heated in an oven at 170° C. for one minute. An adhesive plasticized article was obtained upon cooling to room temperature. The article formed a solution in room temperature water on visual inspection.

To form Example E4, 1 gram of MW 1,000,000 Poly(acrylic acid) (water soluble polymer particles) was blended with 5 grams of MW 400 Poly(ethylene glycol) (plasticizer) to form a slurry. The slurry was poured into an aluminum dish and was heated in an oven at 170° C. for 30 seconds. A plasticized article was obtained upon cooling to room temperature. The article formed a solution in room temperature water on visual inspection, where the water had a pH of 9.

TABLE 3

| | E3 | E4 |
|---|---|---|
| | Wt. % | Wt. % |
| PVP K-120 | 16.67 | — |
| MW 400 Poly(ethylene glycol) | 83.33 | 83.33 |
| MW 1,000,000 Poly(acrylic acid) | — | 16.67 |
| TOTAL | 100.00 | 100.00 |
| Dissolved in Room Temperature Water | Yes | Yes |

To form Example E5, 2 grams of KOLLICOAT IR (water soluble polymer particles) was blended with 9 grams of USP Grade Glycerol (plasticizer) to form a slurry. The slurry was poured into an aluminum dish and was heated in an oven at 170° C. for 30 seconds. A plasticized article was obtained upon cooling to room temperature. The article formed a solution in room temperature water on visual inspection.

To form Example E6, 5 grams of POVAL 49-88 S2 (water soluble polymer particles) was blended with 6 grams of USP Grade Propylene Glycol to form a slurry. The slurry was poured into an aluminum dish and was heated in an oven at 170° C. for 30 seconds. A clear plasticized film was obtained upon cooling to room temperature. The film formed a solution in room temperature water on visual inspection.

TABLE 4

| | E5 | E6 |
|---|---|---|
| | Wt. % | Wt. % |
| KOLLICOAT IR | 18.18 | — |
| USP Grade Glycerol | 81.82 | — |
| POVAL 49-88 S2 | — | 45.45 |
| USP Grade Propylene Glycol | — | 54.55 |
| TOTAL | 100.00 | 100.00 |
| Dissolved in Room Temperature Water | Yes | Yes |

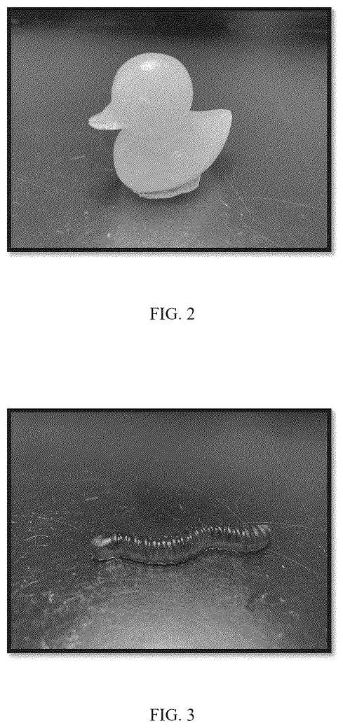

To form Example E7, 10 grams of POVAL 49-88 S2 (water soluble polymer particles) was blended with 90 grams of USP Grade Propylene Glycol (plasticizer) to form a slurry. The slurry was poured into a duck-shaped mold and heated in an oven at 170° C. for 30 minutes. A duck shaped plasticized article was obtained upon cooling to room temperature, as shown in FIG. 2. The plasticized article formed a solution in room temperature water on visual inspection.

To form Example E8, 5 grams of POVAL 49-88 S2 (water soluble polymer particles) was blended with 45 grams of USP Grade Propylene Glycol (plasticizer) and 2 drops of McCormick Green food coloring (additive) to form a slurry). Note that the amount of food coloring added was negligible and was not considered to effect the liquid plastisol composition other than imparting color. The liquid was heated at 170° C. for 10 minutes and poured into a worm-shaped mold. A worm shaped plasticized article was obtained upon cooling to room temperature, as seen in FIG. 3. The plasticized article dissolved in room temperature water on visual inspection.

TABLE 5

| | E7 | E8 |
|---|---|---|
| | Wt. % | Wt. % |
| POVAL 49-88 S2 | 10.00 | 10.00 |
| USP Grade Propylene Glycol | 90.00 | 90.00 |
| TOTAL | 100.00 | 100.00 |
| Dissolved in Room Temperature Water | Yes | Yes |

As exemplified by Examples E1-E8 in Tables 2-8, liquid plastisol compositions including water soluble polymer particles and plasticizer as described herein may be used to form water soluble plasticized articles or films without the need for specialized thermoforming equipment or casting from solvents or water-based solutions.

It will be apparent that modifications and variations are possible without departing from the scope of the disclosure defined in the appended claims. More specifically, although some aspects of the present disclosure are identified herein as preferred or particularly advantageous, it is contemplated that the present disclosure is not necessarily limited to these aspects.

1. A liquid plastisol composition comprising, based on a total weight of the liquid plastisol composition:
3 wt. % to 50 wt. % water soluble polymer particles; and
50 wt. % to 97 wt. % plasticizer,
wherein the water soluble polymer particles have an average particle size from 1 micron to 500 microns.

2. The liquid plastisol composition of claim 1, wherein the liquid plastisol composition is essentially water free.

3. The liquid plastisol composition of claim 1, wherein the liquid plastisol composition further includes 1 wt. % to 20 wt. % of an additive, based on the total weight of the liquid plastisol composition.

4. The liquid plastisol composition of claim 3, wherein the additive is selected from the group consisting of viscosity modifiers, viscosity stabilizers, heat stabilizers, preservatives, fillers, colorants, adhesion promoter, lubricants, and combinations thereof.

5. The liquid plastisol composition of claim 1, wherein the average particle size of the water soluble polymer particles is from 1 micron to 100 microns.

6. The liquid plastisol composition of claim 5, wherein the average particle size of the water soluble polymer particles is from 10 microns to 50 microns.

7. The liquid plastisol composition of claim 1, wherein the water soluble polymer particles comprise a water soluble polymer, the water soluble polymer being selected from the group consisting of polyvinyl alcohols, polyacrylic acid copolymer, poly(2-ethyl-2-oxazoline), and combinations thereof.

8. The liquid plastisol composition of claim 1, wherein the water soluble polymer particles comprise a water soluble polymer, the water soluble polymer being selected from the group consisting of polysaccharides, polypeptides, and combinations thereof.

9. The liquid plastisol composition of claim 1, wherein the plasticizer is a polyol.

10. The liquid plastisol composition of claim 1, wherein the plasticizer is selected from the group consisting of glycols, sugar alcohols, sugars, glycerol, triacetin, propylene carbonate, fatty acids, urea, and combinations thereof.

11. A method of preparing a plasticized composition comprising:
pouring the liquid plastisol composition of claim 1 into a mold; and
heating the liquid plastisol composition to form a gelled plastisol article.

12. The method of claim 11, wherein the step of forming an article from the liquid plastisol composition is performed by screen printing, roll, coating, spray coating, slot die coating, dip molding, dip coating, spin coating, rotomolding, slush casting, injection molding, or extruding.

13. A plasticized article comprising:
a liquid plastisol composition comprising, based on a total weight of the liquid plastisol composition:
3 wt. % to 60 wt. % water soluble polymer; and
40 wt. % to 97 wt. % polyol plasticizer,
wherein the plasticized article comprises a length, a width, and a thickness, each of the length, the width, and the thickness being at least 200 microns.

14. The plasticized article of claim 13, wherein at least 1 gram of the plasticized article is dissolvable in 30 gram of deionized water at standard temperature (20° C.) and pressure (1 atm) and forms a solution in water on visual inspection.

15. The plasticized article of claim 13, wherein each of the length, width, and thickness are at least 500 microns.

16. The plasticized article of claim 15, wherein each of the length, width, and thickness are at least 1 mm.

17. A plasticized film comprising:
a liquid plastisol composition comprising, based on a total weight of the liquid plastisol composition:
3 wt. % to 60 wt. % water soluble polymer; and
40 wt. % to 97 wt. % polyol plasticizer,
wherein the plasticized film comprises a length, a width, and a thickness, the thickness being greater than 200 microns.

18. The plasticized film of claim 17, wherein at least 1 gram of the plasticized film is dissolvable in 30 gram of deionized water at standard temperature (20° C.) and pressure (1 atm) and forms a solution in water on visual inspection.

19. The plasticized film of claim 17, wherein the plasticized film is essentially blister free when viewed at normal viewing angles from a distance of not less than 1000 mm.

20. The plasticized film of claim 17, wherein the plasticized film is a single layer film.
